(19) United States
(12) Patent Application Publication
(10) Pub. No.: US 2013/0158155 A1
(43) Pub. Date: Jun. 20, 2013

(54) COAGENT FOR FREE RADICAL CURING CHLOROROELASTOMERS

(71) Applicant: E I DU PONT DE NEMOURS AND COMPANY, Wilmington, DE (US)

(72) Inventors: Jonathan Aaron KARAS, Solon, OH (US); Peter A. MORKEN, Wilmington, DE (US)

(73) Assignee: E I DU PONT DE NEMOURS AND COMPANY, Wilmington, DE (US)

(21) Appl. No.: 13/676,427

(22) Filed: Nov. 14, 2012

Related U.S. Application Data
(60) Provisional application No. 61/570,880, filed on Dec. 15, 2011.

(51) Int. Cl. C08K 5/57; C08K 5/14

(52) U.S. Cl. CPC C08K 5/57; C08K 5/14
USPC 522/114; 525/274

(57) ABSTRACT

Disclosed herein are curable compositions comprising a chloroelastomer, a free radical generating compound and an unsaturated metal compound coagent. Such compositions cure well, exhibit good (i.e. low) compression set resistance and process well (i.e. have reduced polymer viscosity compared to similar compositions not containing the unsaturated metal compound coagent).

### CROSS-REFERENCE TO RELATED APPLICATIONS

This application claims the benefit of U.S. Provisional Application No. 61/570,880 filed Dec. 15, 2011.

### FIELD OF THE INVENTION

This invention relates to curable chloroelastomer compositions comprising i) a chloroelastomer, ii) a free radical generating compound and iii) an unsaturated metal compound coagent.

### BACKGROUND OF THE INVENTION

Chloroelastomers have been used widely for sealing materials, containers and hoses. Examples of chloroelastomers include polychloroprene, chlorosulfonated polyethylene and chlorinated polyethylene.

In order to fully develop physical properties such as tensile strength, elongation, and compression set, elastomers must be cured, i.e. vulcanized or crosslinked. In the case of chloroelastomers, this is generally accomplished by mixing uncured polymer (i.e. chloroelastomer gum) with a polyfunctional curing agent and heating the resultant mixture, thereby promoting chemical reaction of the curing agent with active sites along the polymer backbone or side chains. Interchain linkages produced as a result of these chemical reactions cause formation of a crosslinked polymer composition having a three-dimensional network structure.

Commonly employed curing agents for chloroelastomers include the combination of a free radical generator, e.g. an organic peroxide, with a multifunctional coagent.

### SUMMARY OF THE INVENTION

In one aspect, the present invention is a curable chloroelastomer composition comprising:
A) a chloroelastomer;
B) a free radical generating compound; and
C) an unsaturated metal compound coagent having the formula Y₍₄₋ₙ₎MXₙ wherein Y is selected from alkyl, aryl, carboxylic acid, or alkyl ester groups; M is selected from Si, Ge, Sn, or Pb; X is an allyl group CR¹R²CR³═CR⁴R⁵, vinyl group CR¹═CR²R³, allenyl group CR¹═C═CR²R³, alkynyl group C≡CR¹, or propargyl group CR¹R²C≡CR³; R¹-R⁵ are selected independently from the group consisting of H, F, alkyl, aryl, heterocycle, or perfluoroalkyl groups; and n is 1, 2, or 3.

### DETAILED DESCRIPTION OF THE INVENTION

The curable compositions of this invention comprise a chloroelastomer, a free radical generating compound and an unsaturated metal compound coagent. Such compositions cure well, exhibit good (i.e. low) compression set resistance and process well (i.e. have reduced polymer viscosity compared to similar compositions not containing the unsaturated metal compound coagent).

Chloroelastomers that may be employed in this invention are substantially free of C—F bonds, i.e. the elastomers contain less than 5 wt % F, preferably 0 wt % F. Specific examples of chloroelastomers that may be employed in the invention include, but are not limited to polychloroprene, chlorosulfonated polyolefins (e.g. chlorosulfonated polyethylene, chlorosulfonated polypropylene, and chlorosulfonated ethylene/α-olefin copolymers), and chlorinated polyolefins (e.g. chlorinated polyethylene, chlorinated polypropylene and chlorinated ethylene/α-olefin copolymers).

Compositions of the invention also contain at least one free radical generating compound. By “free radical generating compound” is meant a compound that upon exposure to heat or actinic radiation decomposes, forming radicals. This includes organic peroxides and photoinitiators.

Organic peroxides suitable for use in the compositions of the invention include, but are not limited to 1,1-bis(t-butylperoxy)-3,5,5-trimethylcyclohexane; 1,1-bis(t-butylperoxy)cyclohexane; 2,2-bis(t-butylperoxy)octane; n-butyl-4,4-bis(t-butylperoxy)valerate; 2,2-bis(t-butylperoxy)butane; 2,5-dimethylhexane-2,5-dihydroxyperoxide; di-t-butyl peroxide; t-butylcumyl peroxide; dicumyl peroxide; alpha,alpha′-bis(t-butylperoxy-m-isopropyl)benzene; 2,5-dimethyl-2,5-di(t-butylperoxy)hexane; 2,5-dimethyl-2,5-di(t-butylperoxy)hexene-3; benzoyl peroxide, t-butylperoxybenzene; 2,5-dimethyl-2,5-di(benzoylperoxy)-hexane; t-butylperoxymaleic acid; and t-butylperoxyisopropylcarbonate. Preferred examples of organic peroxides include 2,5-dimethyl-2,5-di(t-butylperoxy)hexane, dicumyl peroxide, and alpha,alpha′-bis(t-butylperoxy-m-isopropyl)benzene. The amount compounded is generally in the range of 0.05-5 parts by weight, preferably in the range of 0.1-3 parts by weight per 100 parts by weight of the chloroelastomer. This particular range is selected because if the peroxide is present in an amount of less than 0.05 parts by weight, the vulcanization rate is insufficient and causes poor mold release. On the other hand, if the peroxide is present in amounts of greater than 5 parts by weight, the compression set of the cured polymer becomes unacceptably high. In addition, the organic peroxides may be used singly or in combinations of two or more types. In instances where a slow rate of cure is acceptable, the peroxide may be omitted or used at very low level such as 0.02-0.05 phr.

Photoinitiators that may be employed in the compositions of the invention include, but are not limited to benzophenone; acetophenone; benzil; benzaldehyde; o-chlorobenzaldehyde; xanthone; thioxanthone; 9,10-anthraquinone; 1-hydroxycyclohexyl phenyl ketone; 2,2-diethoxyacetophenone; dimethoxyphenylacetophenone; methyl diethanolamine; dimethylaminobenzoate; 2-hydroxy-2-methyl-1-phenylpropane-1-one; 2,2-di-sec-butoxyacetophenone; 2,2-dimethoxy-1,2-diphenylethan-1-one; benzil dimethoxyketal; benzoin methyl ether; and phenyl glyoxal. The amount compounded is generally in the range of 0.05-5 parts by weight, preferably in the range of 0.1-3 parts by weight per 100 parts by weight of the chloroelastomer.

The unsaturated metal compound coagent employed in the compositions of the invention is a derivative of silicon, germanium, tin, or lead that has at least one vinyl, allyl, allenyl, alkynyl, or propargyl group attached to the metal. The general formula is Y₍₄₋ₙ₎MXₙ wherein Y is selected from alkyl, aryl, carboxylic acid, or alkyl ester groups. The Y groups on one molecule of this coagent may be selected from more than one group. M is selected from Si, Ge, Sn, or Pb; X is an allyl group CR¹R²CR³═CR⁴R⁵, vinyl group CR¹═CR²R³, allenyl group CR¹═C═CR²R³, alkynyl group C≡CR¹, or propargyl group CR¹R²C≡CR³; R¹-R⁵ are selected independently from the group consisting of H, F, alkyl, aryl, heterocycle, or perfluoroalkyl groups; and n is 1,2, or 3. The R¹-R⁵ group may be a mixed alkyl and perfluoroalkyl group such as CF₃(CF₂)₅CH₂CH₂—. Preferred for Y groups are phenyl groups or alkyl groups. Most preferred Y groups are alkyl groups, particularly where each alkyl group has 4, 6 or 8 carbon atoms. Carboxylic acid Y groups can be for example octanoic or stearic acid or a diacid such as maleic acid. Allyl and vinyl groups are preferred for X and allyl is most preferred. It is preferred that n is 1 or 2 and most preferred that n is 1. It is preferred that the R¹⁻⁵ groups be H or F and most preferably H. Introduction of an excess of non-hydrogen R groups on the unsaturated X group can be detrimental to performance due to steric hindrance. However introduction of 1, 2 or 3 non-hydrogen groups can in some instances improve performance. The syntheses of unsaturated tin compounds is described for example in Organotin Chemistry, 2^{nd} Ed. (Wiley-VCH, 2004, Weinheim, Germany, Alwyn G. Davies author).

Specific examples of unsaturated metal compound coagents suitable for use in this invention include, but are not limited to allyltributyltin, methallyltri-n-butyltin, diallyldibutyltin, allyltriphenyltin, tributyl(vinyl)tin, diallyldioctyltin, allyltriphenylstannane, allyltriphenylgermane, allyltriphenylplumbane, vinyltriphenyltin, allyltriphenylsilane, allyltrioctylstannane, allyltrioctylgermane, vinyltrioctylstannane, and divinyldioctylstannane.

The amount of unsaturated metal compound can be about 0.1 to 8 parts by weight, preferably 0.2 to 4 parts by weight, more preferably 0.5 to 3 parts by weight per 100 parts by weight chloroelastomer.

Compositions of the invention have a lower viscosity than do similar compositions that lack the unsaturated metal compound coagent. Without being bound by theory, it is believed that the unsaturated metal compounds of this invention reduce viscosity of rubber compounds by interacting with the acid or salt endgroups of the chloroelastomer.

Optionally, the compositions of the invention may further comprise a conventional multifunctional coagent of the type typically employed in the free radical curing of chloroelastomers. Such multifunctional coagents include, but are not limited to unsaturated compounds such as triallyl cyanurate, trimethacryl isocyanurate, triallyl isocyanurate, trimethallyl isocyanurate, triacryl formal, triallyl trimellitate, N,N′-m-phenylene bismaleimide, diallyl phthalate, tetraallylterephthalamide, tri(diallylamine)-s-triazine, triallyl phosphite, bis-olefins and N,N-diallylacrylamide. When present, the amount compounded is generally in the range of 0.1-10 (preferably 0.2-6) parts by weight per 100 parts by weight of the chloroelastomer. The optional unsaturated compounds may be used singly or as a combination of two or more types.

The curable compositions of the invention may also optionally contain 1 to 20 parts by weight (preferably 2 to 5 parts) of at least one acid acceptor (e.g. zinc oxide, magnesium oxide, calcium hydroxide, hydrotalcite) per hundred parts by weight chloroelastomer.

Other ingredients (e.g. fillers, colorants, process aids, etc.) commonly employed in elastomer compositions may also be included in the curable compositions of the invention.

The chloroelastomer, free radical generating compound, unsaturated metal compound coagent and any other ingredients are generally incorporated into a curable composition by means of an internal mixer or rubber mill. The resulting composition may then be shaped (e.g. molded or extruded) and cured to form a rubber article. Curing typically takes place at about 140°-200° C. for 2 to 30 minutes. Conventional rubber curing presses, molds, extruders, and the like provided with suitable heating and curing means can be used.

### EXAMPLES

### Test Methods

Cure characteristics were measured using a Monsanto Moving Die Rheometer (MDR 2000) instrument under the following conditions:

Moving die frequency: 1.66 Hz

Oscillation amplitude: 0.5

Temperature: 177° C. unless otherwise indicated

Duration of test: 24 minutes

The following cure parameters were recorded:

M_{H}: maximum torque level, in units of dN·m

M_{L}: minimum torque level, in units of dN·m

tₛ2: minutes to 2 units rise above M_{L}

t50: minutes to 50% of maximum torque

t90: minutes to 90% of maximum torque

Tensile properties were determined by ASTM D412.

Compression set resistance was measured according to ASTM D395.

The invention is further illustrated by, but is not limited to, the following examples.

### Examples 1-2 and Comparative Example A

Curable compositions for Examples 1-2 and Comparative Example A were made by compounding the ingredients on a two-roll mill. Formulations are shown in Table I. Chloroelastomer 1 was Neoprene W, a polychloroprene, available from DuPont.

The compositions were molded into slabs and o-rings by press curing at 177° C. for 10 minutes. Cure characteristics and physical properties are also shown in Table I.

The data shows that addition of an allyl tin coagent to polychloroprene causes a reduction in Mooney viscosity and a decrease in compression set when used as the sole free radical coagent or in combination with triallyl cyanurate (TAC).

TABLE I

| | Comparative | Example | Example |
|---|---|---|---|
| | Example A | 1 | 2 |
| Ingredient, phr¹ | | | |
| Chloroelastomer 1 | 100 | 100 | 100 |
| N762 Carbon Black | 58 | 58 | 58 |
| Sundex 790² | 10 | 10 | 10 |
| AgeRite Stalite S³ | 2 | 2 | 2 |
| Polyethylene 617A⁴ | 1 | 1 | 1 |
| Maglite D⁵ | 4 | 4 | 4 |
| Zinc Oxide | 5 | 5 | 5 |
| Di-Cup 40C⁶ | 1.5 | 1.5 | 1.5 |
| TAC DLC-A⁷ | 0.7 | 0.7 | |
| Allyltributylstannane | | 2.5 | 2.5 |
| Microcel E⁸ | 1 | 1 | 1 |
| Mooney Viscosity, 100° C. | | | |
| ML(1 + 10) | 54.7 | 42.9 | 43.5 |
| Curing Characteristics | | | |
| ML, dNm | 1.5 | 1.2 | 1.21 |
| MH, dNm | 18.74 | 15.5 | 15.96 |
| ts2, minutes | 0.67 | 0.7 | 0.67 |
| t50, minutes | 2.55 | 2.29 | 2.27 |
| t90, minutes | 12.04 | 11.11 | 10.6 |
| Compression set, 25% Deflection | | | |
| Compression Set 100° C., 70 h, % | 59 | 55 | 53 |
| Physical Properties | | | |
| Hardness, Shore A | 61 | 54 | 56 |
| M50, MPa | 1.5 | 1.18 | 1.26 |
| M100, MPa | 2.92 | 2.03 | 2.36 |
| M200, MPa | 8.46 | 5.74 | 6.89 |
| M300, MPa | 15.48 | 11.01 | 12.98 |
| Tb, MPa | 19.65 | 17.67 | 17.99 |
| Eb (%) | 385 | 445 | 413 |
| Tensile (20°) Hot Air | | | |
| Aged 70 h/100° C. | | | |
| Hardness, % retention | 115 | 120 | 118 |
| M50, % retention | 141 | 132 | 142 |
| M100, % retention | 140 | 144 | 144 |
| M200, % retention | 121 | 133 | 127 |
| M300, % retention | 109 | 123 | 115 |
| Tb, % retention | 95 | 95 | 98 |
| Eb, % retention | 87 | 85 | 90 |

¹parts by weight per hundred parts rubber (i.e. chloroelastomer)
²high aromatic process oil available from Sunoco
³octylated diphenylamines available from R. T. Vanderbilt Co., Inc
⁴lower crystallinity, low molecular weight polyethylene available from Honeywell.
⁵magnesium oxide available from HallStar
⁶organic peroxide available from Arkema Inc.
⁷72% triallyl cyanurate on silica, available from Natrochem, Inc., Savannah, GA
⁸Calcium metasilicate available from Celite Corporation

### Examples 3-4 and Comparative Example B

Curable compositions for Examples 3-4 of the invention and Comparative Example B were made by compounding the ingredients on a two roll mill. Formulations are shown in Table II. Chloroelastomer 2 was Hypalon® 40, a chlorosulfonated polyethylene, formerly available from DuPont.

The compositions were molded into slabs and o-rings by press curing at 177° C. for 10 minutes. Cure characteristics and physical properties are also shown in Table II.

The data shows that addition of an allyl tin coagent to chlorosulfonated polyethylene causes a reduction in Mooney viscosity and participates in the free radical curing of the elastomer.

TABLE II

| | Comparative | Example | Example |
|---|---|---|---|
| | Example B | 3 | 4 |
| Ingredient, phr | | | |
| Chloroelastomer 2 | 100 | 100 | 100 |
| N762 Carbon Black | 100 | 100 | 100 |
| Trioctyl Trimellitate⁹ | 20 | 20 | 20 |
| Polyethylene 617A | 3 | 3 | 3 |
| Pentaerythritol 200 Mesh¹⁰ | 5 | 5 | 5 |
| Maglite D | 10 | 10 | 10 |
| Di-Cup 40C | 8 | 8 | 8 |
| TAC DLC-A | 4.2 | 4.2 | |
| Allyltributylstannane | | 2.5 | 2.5 |
| Microcel E | 1 | 1 | 1 |
| Mooney Viscosity, 100° C. | | | |
| ML(1 + 10) | 83.1 | 68.4 | 75.7 |
| Curing Characteristics | | | |
| ML, dNm | 2.37 | 2.13 | 1.87 |
| MH, dNm | 31.45 | 28.64 | 10.36 |
| ts2, minutes | 0.53 | 0.57 | 0.73 |
| t50, minutes | 2.27 | 2.19 | 2.18 |
| t90, minutes | 6.5 | 6.33 | 7.27 |
| Compression set, 25% Deflection | | | |
| Compression Set 125° C. 70 h, % | 51 | 57 | 95 |
| Physical Properties | | | |
| Hardness, Shore A | 79 | 81 | 76 |
| M50, MPa | 5.24 | 5.54 | 2.49 |
| M100, MPa | 15.3 | 14.47 | 4.1 |
| M200, MPa | 0 | 0 | 7.38 |
| M300, MPa | 0 | 0 | 7.91 |
| Tb, MPa | 19.05 | 17.34 | 7.97 |
| Eb (%) | 123 | 128 | 267 |
| Tensile (20°) Hot Air | | | |
| Aged 168 h/150° C. | | | |
| Hardness, % retention | 102 | 106 | 108 |
| M50, % retention | 172 | 193 | 260 |
| M100, % retention | 0 | 0 | 0 |
| Tb, % retention | 72 | 71 | 59 |
| Eb, % retention | 61 | 48 | 39 |

⁹Primary branched monomeric plasticizer available from HallStar
¹⁰Fine particle size available from Harwick Standard Distribution Corp.

### Examples 5-6 and Comparative Example C

Curable compositions for Examples 5-6 of the invention and Comparative Example C were made by compounding the ingredients on a two roll mill. Formulations are shown in Table III. Chloroelastomer 3 was Tyrin® CM0730, a chlorinated polyethylene, available from The Dow Chemical Company.

The compositions were molded into slabs and o-rings by press curing at 177° C. for 10 minutes. Cure characteristics and physical properties are also shown in Table III.

The data shows that addition of an allyl tin coagent to chlorinated polyethylene causes a reduction in Mooney viscosity and participates in the free radical curing of the elastomer.

TABLE III

| | Comparative | Example | Example |
|---|---|---|---|
| | Example C | 5 | 6 |
| Ingredient, phr | | | |
| Chloroelastomer 3 | 100 | 100 | 100 |
| N762 Carbon Black | 100 | 100 | 100 |
| Trioctyl Trimellitate | 20 | 20 | 20 |
| Polyethylene 617A | 1 | 1 | 1 |
| Maglite D | 15 | 15 | 15 |
| Di-Cup 40C | 8 | 8 | 8 |
| TAC DLC-A | 4.2 | 4.2 | |
| Allyltributylstannane | | 2.5 | 2.5 |
| Microcel E | 1 | 1 | 1 |
| Mooney Viscosity, 121° C. | | | |
| ML(1 + 10) | 102.2 | 95.1 | 101.8 |
| Curing Characteristics | | | |
| ML, dNm | 3.89 | 4.46 | 4.65 |
| MH, dNm | 50.39 | 47.56 | 28.61 |
| ts2, minutes | 0.31 | 0.37 | 0.43 |
| t50, minutes | 1.04 | 1.17 | 1.41 |
| t90, minutes | 3.17 | 3.43 | 3.86 |
| Compression Set, 25% Deflection | | | |
| Compression Set 125° C. 70 h, % | 39 | 40 | 55 |
| Compression Set 125° C. 168 h, % | 52 | 56 | 78 |
| Physical Properties | | | |
| Hardness, Shore A | 87 | 86 | 83 |
| M50, MPa | 6.71 | 7.17 | 3.92 |
| M100, MPa | 18.33 | 18.74 | 8.95 |
| Tb, MPa | 20.26 | 20.6 | 18.95 |
| Eb (%) | 112 | 113 | 191 |
| Tensile (20°) Hot Air | | | |
| Aged 168 h/150° C. | | | |
| Hardness, % retention | 108 | 112 | 115 |
| M50, % retention | 0 | 0.00 | 0 |
| Tb, % retention | 66 | 73 | 77 |
| Eb, % retention | 23 | 18 | 5 |

What is claimed is:

1. A curable chloroelastomer composition comprising:
A) a chloroelastomer;
B) a free radical generating compound; and
C) an unsaturated metal compound coagent having the formula Y₍₄₋ₙ₎MXₙ wherein Y is selected from alkyl, aryl, carboxylic acid, or alkyl ester groups; M is selected from Si, Ge, Sn, or Pb; X is an allyl group CR¹R²CR³═CR⁴R⁵, vinyl group CR¹═CR²R³, allenyl group CR¹═C═CR²R³, alkynyl group C≡CR¹, or propargyl group CR¹R²C≡CR³; R¹-R⁵ are selected independently from the group consisting of H, F, alkyl, aryl, heterocycle, or perfluoroalkyl groups; and n is 1, 2, or 3.

2. The curable composition of claim 1 wherein said unsaturated metal compound coagent is of the formula Y₍₄₋ₙ₎MXₙ wherein M is Sn, X is allyl group CR¹R²CR³═CR⁴R⁵, Y is alkyl or aryl, R¹-R⁵ are H and n is 1 or 2.

3. The curable composition of claim 2 wherein said unsaturated metal compound coagent is allyltrioctylstannane.

4. The curable composition of claim 2 wherein said unsaturated metal compound coagent is allyltriphenylstannane.

5. The curable composition of claim 2 wherein said unsaturated metal compound coagent is diallyldioctylstannane.

6. The curable composition of claim 1 wherein said unsaturated metal compound coagent is of the formula Y₍₄₋ₙ₎MXₙ wherein M is Sn, X is vinyl group CR¹═CR²R³, Y is alkyl or aryl, R¹-R³ are H and n is 1.

7. The curable composition of claim 6 wherein said unsaturated metal compound coagent is vinyltrioctylstannane.

8. The curable composition of claim 6 wherein said unsaturated metal compound coagent is vinyltriphenylstannane.

9. The curable composition of claim 1 wherein said unsaturated metal compound coagent is of the formula Y₍₄₋ₙ₎MXₙ wherein M is Ge, X is allyl group CR¹R²CR³═CR⁴R⁵, Y is alkyl or aryl, R¹-R⁵ are H and n is 1.

10. The curable composition of claim 9 wherein said unsaturated metal compound coagent is allyltrioctylgermane.

11. The curable composition of claim 9 wherein said unsaturated metal compound coagent is allyltriphenylgermane.

12. The curable composition of claim 1 further comprising a multifunctional coagent.

13. The curable composition of claim 12 wherein said multifunctional coagent is selected from the group consisting of triallyl cyanurate, trimethacryl isocyanurate, triallyl isocyanurate, trimethallyl isocyanurate, triacryl formal, triallyl trimellitate, N,N′-m-phenylene bismaleimide, diallyl phthalate, tetraallylterephthalamide, tri(diallylamine)-s-triazine, triallyl phosphite, bis-olefins and N,N-diallylacrylamide.

14. The curable composition of claim 13 wherein said multifunctional coagent is triallyl isocyanurate.

15. The curable composition of claim 1 wherein said free radical generating compound is an organic peroxide.

16. The curable composition of claim 1 wherein said free radical generating compound is a photoinitiator.
